(19) United States
(12) Patent Application Publication
(10) Pub. No.: US 2023/0358013 A1
(43) Pub. Date: Nov. 9, 2023

(54) METHOD AND DEVICE FOR CONTROLLING THE ACTUATION OF A MECHANICAL BUCKET OF A WORKING VEHICLE (WL)

(71) Applicant: CNH Industrial America LLC, New Holland, PA (US)

(72) Inventors: Adriano Garramone, Lecce (IT); Andrea Gravili, Lecce (IT); Stefano Liberti, Lecce (IT); Antonio Venezia, Torino (IT)

(21) Appl. No.: 18/028,526

(22) PCT Filed: Sep. 27, 2021
(86) PCT No.: PCT/EP2021/076433

§ 371 Date: Mar. 25, 2023

(30) Foreign Application Priority Data
Sep. 25, 2020 (IT) 102020000022744

(51) Int. Cl. E02F 3/43; E02F 9/20; E02F 3/34; E02F 3/407

(52) U.S. Cl. CPC E02F 3/434; E02F 9/2004; E02F 3/34; E02F 3/4075; E02F 9/2203

(57) ABSTRACT

Control method for actuating a loader (WL) comprising an arm (B) to which a bucket (BK) is connected, the method comprising in cyclic execution checks (FB) that a first mono-stable button is depressed, if it is depressed, then execution (Sequence) of the following sequence of operations: unloading, shaking, returning to dig position or if the vehicle is equipped with a 4 in 1 shovel: unloading, 4 in 1 shovel opening, shaking, 4 in 1 shovel closing, returning to dig position, otherwise if the first button (FB) is released then stop (STOP) of the execution of the sequence.

### FIELD OF THE INVENTION

The present invention relates to the field of actuation controls of a mechanical bucket of a work vehicle.

### STATE OF THE ART

DE102014111505A1 discloses a hydrostatic drive system with at least one hydraulic member, which is controlled by a directional control valve. An electronic control device generates an actuation signal to operate the directional control valve when a button is depressed so as to generate a shaking function of the hydraulic implement when the button is depressed. The shaking function generates a signal that is added to a control signal of the hydraulic implement.

It is therefore clear that the movement of the arm and bucket are managed by the operator, while the corresponding control signals are added to those deriving from the shaking function. US2018135274 describes another control system similar to the previous one, in which however the purpose is to sieve, namely to spread material, typically gravel, on the ground, while the bucket and the relative arm are in an approximately fixed position suitable for the operation of sieving with oscillations in an horizontal plane.

It is believed that this level of aid for the operator is not sufficient when the main purpose is to empty the bucket of material, such as mud, which sticks to the bucket itself.

Therefore, the aim is not to spread some gravel equally on the ground, but rather to free the bucket of attached previously collected material.

If not specifically excluded in the detailed description that follows, what is described in this chapter is to be considered as an integral part of the detailed description.

### SUMMARY OF THE INVENTION

The purpose of the present invention is to present a method and system for emptying the bucket to assist the operator of a work vehicle equipped with a mechanical bucket.

The basic idea of the present invention is to activate an unloading function which, in a fully automatic way, performs a sequence of at least three operations: unloading, shaking, return of the bucket to the excavation position (dig).

The three movements are performed in succession, therefore, this solution differs from DE102014111505A1 in that, in this document, the system is limited to adding a shaking signal, while the movement remains under the control of the operator, and differs from US2018135274, according to which, the average position of the bucket remains the same although the organ oscillates around it.

Preferably, the sequence of operations is active when a mono-stable button is depressed and stops immediately when the button is released.

Preferably, the sequence is activated only when the arm is raised beyond a predetermined settable height threshold, for example 50% of the maximum height.

Some vehicles are equipped with a bucket called “4 in 1”, which is equipped with two hydraulic actuators placed on the rear of the bucket that allow the opening of the front section for unloading the material. In this case, by means of the first button an unloading function is activated which, in a completely automatic way, carries out the following sequence of operations: unloading, 4 in 1 bucket opening, shaking, 4 in 1 bucket closing, 4 in 1 bucket return. 1 in the dig position (dig).

Some vehicles are equipped with an additional function, which can also be activated via an additional button, which allows the lifting of the arm with the coordinated movement of the bucket full of material until a predetermined height is reached, for example 80% of the maximum height, therefore, the functionalities implemented through the first button are complementary to this additional function.

The “coordinated” movement means that the bucket lifts and orientates itself automatically without dropping material.

In the present description the terms shovel and bucket are used indifferently, meaning a tool capable of collecting fragmentary material such as earth, stones, gravel and the like and combinations thereof.

According to another preferred variant of the invention, the sequence also includes lifting the arm until a predetermined settable height is reached, for example 80% of the maximum height, when the arm is lower than a predetermined height, for example the 80% of the maximum height. Therefore, the sequence includes: lifting, unloading, shaking, returning the bucket to the dig position with the lowering of the arm until reaching a predetermined settable height, for example 20% of the maximum altitude. If the vehicle is equipped with a 4-in-1 loader, the sequence includes: lifting, unloading, opening the 4-in-1 loader, shaking, closing the 4 in 1 loader, returning the 4 in 1 loader to the dig position and lowering the boom to achievement of a predetermined settable quota, for example 20% of the maximum height.

According to a preferred variant of the invention, this unloading function is active when it is “allowed” by means of a second command.

According to a preferred variant of the invention, which depends on the previous one, when the unloading function is disabled, the pressure of the mono-stable button only causes the bucket to shake, as long as the button is depressed.

This means that the first button, preferably arranged on the joystick for controlling the bucket and arm, performs two different functions in relation to the position of the second control.

The dependent claims describe preferred variants of the invention, forming an integral part of this description.

### BRIEF DESCRIPTION OF THE FIGURES

Further objects and advantages of the present invention will become clear from the following detailed description of an example of its embodiment (and its variants) and from the attached drawings given purely by way of non-limiting explanation, in which:

FIG. 1 shows an example of a work vehicle;

FIG. 2 shows an example of a flow chart relating to the function (s) object of the present invention;

FIG. 3 shows an electro-hydraulic diagram for controlling the operation of an arm and a bucket of a work vehicle according to the present invention;

FIGS. 4 and 5 show preferred variants of the invention by means of as many flow diagrams.

The same reference numbers and letters in the figures identify the same elements or components or functions;

FIG. 6 shows an example of a joystick equipped with buttons including at least one implemented to carry out the present invention.

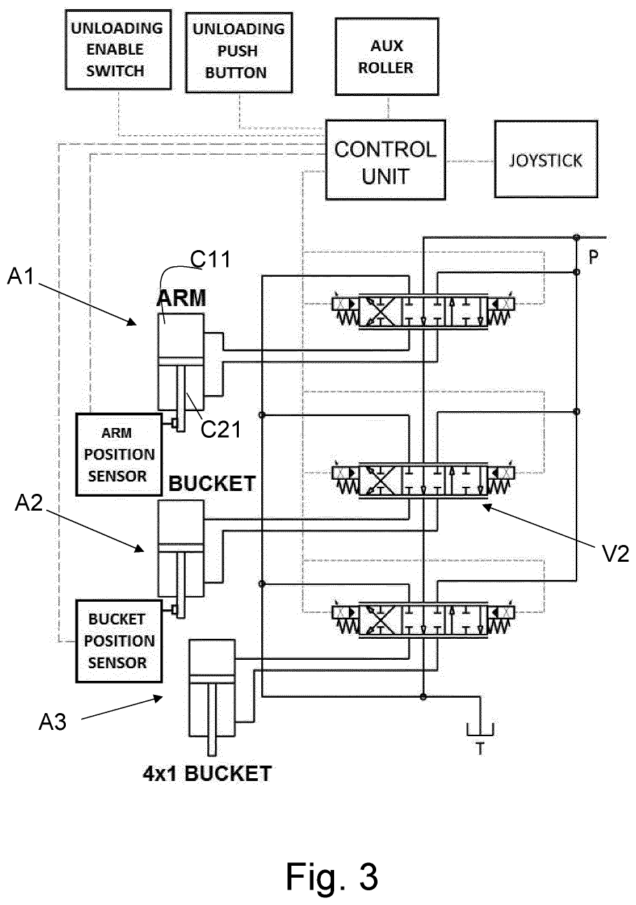

The blocks of FIG. 2 represented in broken lines are optional.

In the context of this description, the term “second” component does not imply the presence of a “first” component. These terms are in fact used as labels to improve clarity and should not be understood in a limiting way.

The elements and features illustrated in the various preferred embodiments, including the drawings, can be combined with each other without however departing from the scope of this application as described below.

### EXEMPLARY DESCRIPTION OF PREFERRED EMBODIMENTS

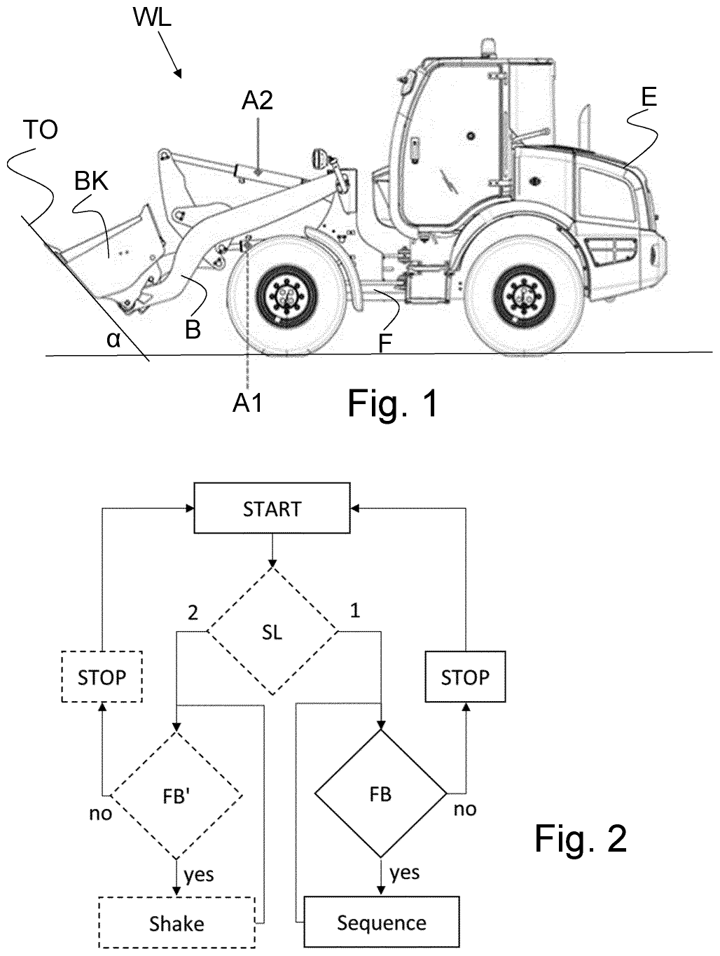

FIG. 1 shows an example of a work vehicle WL equipped with a mechanical bucket BK. This essentially includes an arm B hinged to the chassis F of the vehicle and a bucket BK hinged to the other end of the arm B.

A pair of hydraulic actuators A1 and A2 are responsible for moving the arm with respect to the vehicle frame and the bucket with respect to the arm respectively.

Another actuator A3 deals with opening and closing the bucket when it is of the 4 in 1 type.

If the bucket is monolithic, obviously, the A3 actuator is not present.

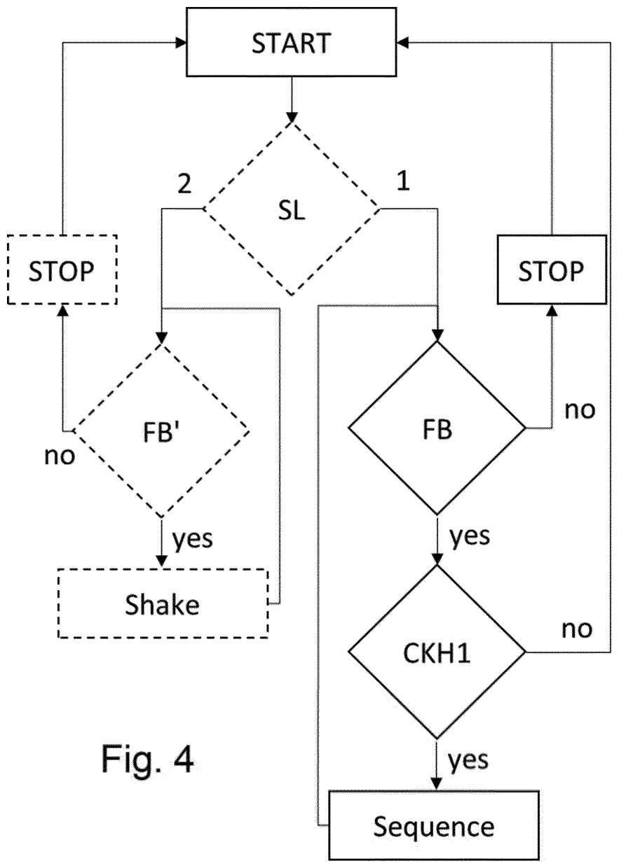

FIG. 3 shows a hydraulic control circuit of actuators A1, A2 and A3 in which the first actuator A1 is indicated with “ARM” to refer to the actuated member, namely arm B; the second actuator A2 is indicated with “BUCKET”; while the third actuator A3 is indicated with “4×1 BUCKET” to refer to the opening and closing of the 4-in-1 bucket. “T” identifies the tank into which the hydraulic fluid is discharged.

The tank T is at atmospheric pressure and from this tank a hydraulic pump, generally driven in rotation by the prime mover, generally thermal, draws the hydraulic liquid to be pressurized.

Valve V1 controls the operation of actuator A1 or ARM. Valve V1 is represented with three spools, in which the central spool is at rest.

When no command reaches valve V1, the central spool is therefore active. In rest conditions, the hydraulic liquid coming from the pump, indicated with the letter “P”, is directed to the collection tank T.

The two side spools with respect to the central one allow the first one, for example to the right of the central one, to pressurize chamber C11 of actuator A1 by connecting chamber C12 with tank T. The second spool performs the exact opposite function, i.e. it connects the chamber C12 with the pump and chamber C11 with the tank T.

Although the hydraulic pump is not shown, the circuit indicates the connection to it with the letter P.

The description of the first actuator A1 also applies to the second actuator A2, which directs the bucket BK with respect to the arm B and to the third actuator “4×1 BUCKET” which opens and closes the 4-in-1 bucket.

An arm position sensor called “ARM POSITION SENSOR” and a bucket position sensor called “BUCKET POSITION SENSOR” respectively and preferably associated with the hydraulic actuators A1 and A2, respectively determine the position of the arm with respect to the frame and of the bucket with respect to the arm.

A “Control Unit” processing unit controls the operation of all the valves as well as receiving signals from the boom and bucket position sensors, from commands such as
Joystick,
“AUX ROLLER”,
“UNLOADING ENABLE SWITCH”,
“UNLOADING PUSH BUTTON”,
   described in detail below.

With reference to FIG. 2, the present invention presents an actuation control method of a work vehicle WL comprising an arm B to which a bucket BK is connected: the method comprises in cyclical execution
FB checking that a first mono-stable button, called “Unloading Push Button” is depressed, if it is depressed, then in the positive case (yes)
execution (Sequence) of the following sequence of operations: unloading, shaking, returning to digging position or if the vehicle is equipped with a 4 in 1 bucket the sequence of operations: unloading, 4 in 1 bucket opening, shaking, 4 bucket closing in 1, return to dig position or otherwise if the first mono-stable key is released (no) then
stop (STOP) of the sequence execution.

With reference to FIG. 1, the orientation of the bucket BK forms a positive angle α with the support plane of the vehicle. When the bucket is unloaded, it is turned downwards forming a negative angle with respect to the vehicle support surface.

The shaking is preferably carried out near the maximum negative angle that the bucket can form with respect to the support plane of the vehicle.

The duration and intensity of the shaking can be set by means of man/machine interface.

At the end of the shaking operation, the arm lowers and the bucket orientates itself in the excavation position which consists in forming an approximately zero angle between the bucket and the vehicle support surface.

Once the digging position has been reached, pressing the first key has no effect, therefore to execute the sequence again it is necessary to release and press the first key again.

Generally, the unloading of the material takes place inside a load compartment of a heavy vehicle. After the shaking operation, the lowering of the arm could interfere with the sides of the load compartment of the heavy vehicle. For this purpose, releasing the first button stops the execution of the sequence of operations but keeps the sequence status memory. Thus, by returning to press the first button, the execution of the sequence of operations resumes from the point at which it was interrupted.

This fact is particularly advantageous, as it allows the operator to move the work vehicle WL away from the heavy vehicle and continue the execution of the sequence which consists in lowering the arm with the return of the bucket to the excavation position, without hitting the side of the load compartment.

Preferably, on the vehicle control panel there is a second command called “Unloading Enable switch” which can assume two positions (bistable): a first position (1) and a second position (2). The method preferably comprises a preliminary step SL of verifying a position of the second bistable control and carrying out the Sequence of operations for the bucket: unloading, shaking, returning to excavation position; or if the vehicle is equipped with a 4 in 1 bucket: unload, open 4 in 1 bucket, shake, close 4 in 1 bucket, return to dig position when the second command is in a first position (1) and executing only shaking when the second control is in a second position (2).

The execution of the shaking only, when the second bistable button is in the second position (2), is performed around the position in which the bucket is when the first mono-stable button is depressed, therefore, if the operator wishes the shaking occurs in the unloading position of the bucket, the operator must operate the bucket by bringing it to the unloading position. This operation can be performed before but also during the activation of the shaking. In other words, the oscillation signal that controls the second actuator is added to the drive signal given by the operator to bring the bucket to the desired position.

Therefore, when the second command is in the second position (2), the shaking operation is performed as long as the first button is depressed (yes).

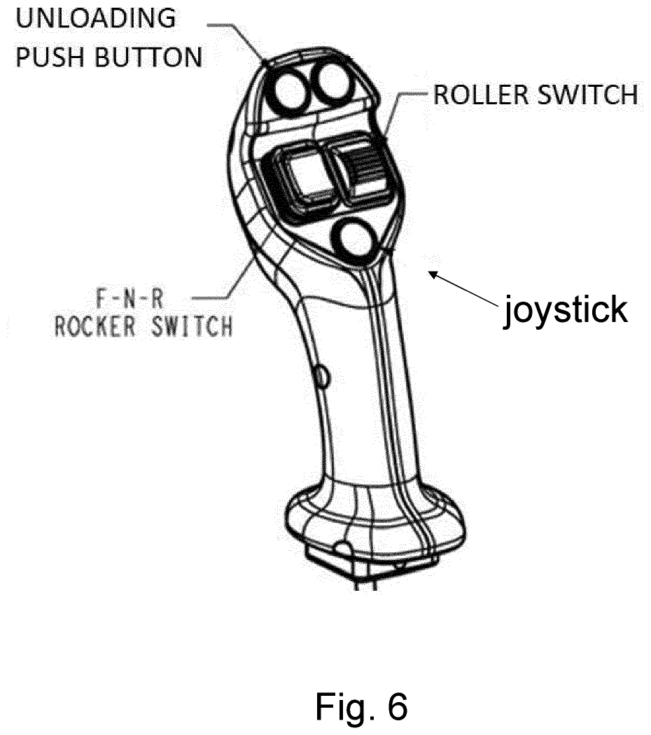

Generally, a control lever, such as a joystick shown in FIG. 6 is arranged to control the operation of the arm B and of the bucket and a roller control called “ROLLER SWITCH”, preferably associated with the joystick so that it can be operated comfortably and independently of the first button, it is arranged to operate the 4-in-1 bucket. Preferably, the first button “UNLOADING PUSH BUTTON” is also associated with the joystick.

The Joystick can also be equipped with additional buttons, for example the “F-N-R ROCKER SWITCH” button which is used to control the vehicle transmission for moving the wheels.

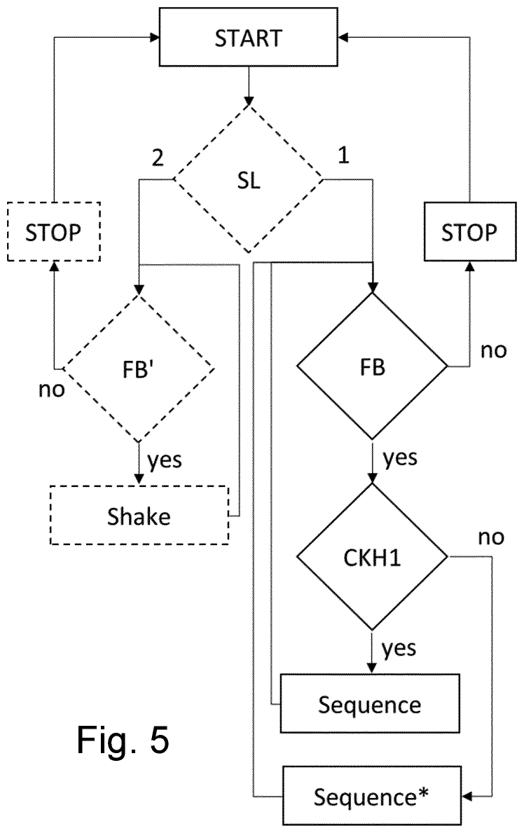

FIG. 4 shows a variant according to which, in addition to pressing the first button CKH1, the elevation position of the arm is checked. If CKH1 the height of the arm is above a predetermined threshold (yes) then proceeding with the execution of the sequence, otherwise coming back to the beginning. In other words, the diagram of FIG. 4 avoids starting the unloading procedure if the arm is in a low position.

According to the diagram in FIG. 5, if it appears that the arm is raised beyond a predetermined height CKH1=yes, then the sequence “sequence” is executed, otherwise a modified sequence “sequence*” is executed, in fact it is marked with an asterisk. This modified sequence includes the preliminary lifting of the arm to a predetermined height.

Preferably, this height can be set by the operator in relation to the circumstances. For example, if it is necessary to load the load compartment of a heavy vehicle whose sides have a certain height, the operator can set the lifting of the arm as strictly necessary not to interfere with the sides of the load compartment. This guarantees high productivity.

There are vehicles equipped with a function that allows the arm to be automatically raised to a preset height while the loader is loaded. In this case, the lifting operation can be performed with a third button, while the sequence is performed with the first button in accordance with the diagram in FIG. 2 or 4.

One of the most interesting aspects of the present invention is the fact that releasing the first button does not cancel the sequence but interrupts it to resume when the button is depressed again.

The sequence stops permanently if
it is carried out integrally until the bucket is repositioned in the excavation position;
the operator intervenes on the joystick that controls the arm and/or bucket,
the operator intervenes on the “Roller” that controls the 4 in 1 bucket;
the operator switches the second command from the first to the second position.

Another interesting aspect of the invention is that the same button can perform a sequence of operations including or not the lifting of the arm, or the simple shaking of the bucket.

The present invention can be advantageously realized by means of a computer program, which comprises coding means for carrying out one or more steps of the method, when this program is executed on a computer. Therefore it is intended that the scope of protection extends to said computer program and further to computer readable means comprising a recorded message, said computer readable means comprising program coding means for carrying out one or more steps of the method, when said program is run on a computer.

Implementation variants of the described non-limiting example are possible, without however departing from the scope of protection of the present invention, including all the equivalent embodiments for a person skilled in the art, to the content of the claims.

From the above description, the person skilled in the art is able to realize the object of the invention without introducing further construction details.

1. A method for controlling actuation of a loader comprising an arm to which a bucket is connected, the method comprising in succession:
checking that a first mono-stable key is depressed, in response to the mono-stable key being depressed, then in the positive case:
execution of a sequence of operations comprising unloading, shaking, and returning the bucket to dig position, otherwise in response to the first mono-stable key being released:
stopping of the sequence execution.

2. The method according to claim 1, wherein the bucket is of the 4-in-1 type, and the sequence comprises unloading, opening the bucket, shaking, closing the bucket, and returning the bucket to the dig position.

3. The method according to claim 1, wherein after stopping the execution of the sequence, in response to the first mono-stable key being depressed, resuming the sequence from a stop condition until the bucket returns to the dig position.

4. The method according to claim 1, further comprising a preliminary step of verifying a position of a second control, bistable, and executing the sequence of operations when the second control is in a first position and carrying out only the shaking when the second control is in a second position.

5. The method according to claim 4, wherein when the second control is in the second position, the shaking is performed as long as the first mono-stable key is depressed.

6. The method according to claim 4, wherein when the second control is in the second position and the first mono-stable key is depressed, a control lever is configured to control the positioning of the arm and/or the bucket at the same time as the shaking.

7. The method according to claim 1, wherein the sequence of operations is performed only in response to verifying that the arm is raised beyond a first predetermined height threshold.

8. The method according to claim 1, comprising verifying that the arm is raised above a second predetermined threshold, wherein in the affirmative case, the sequence is performed, otherwise in the negative case, the sequence is performed and includes prior lifting of the arm.

9. (canceled)

10. Computer readable media comprising a recorded program adapted to perform all steps of the method of 1, when the recorded program is run on a computer.

11. A loader comprising an arm to which a bucket is connected, a first mono-stable key, and a processing unit arranged for:
checking that the first mono-stable key is depressed, in response to the first mono-stable key being depressed, then in the positive case:
executing a sequence of operations comprising unloading, shaking, and returning the bucket to dig position, otherwise in response to the first mono-stable key being released:
stopping the sequence execution.

12. The loader according to claim 11, wherein the bucket is of the 4-in-1 type, and the sequence of operations comprises unloading, opening the bucket, shaking, closing the bucket, and returning the bucket to the dig position.

13. The loader of claim 11, wherein the first mono-stable key is associated with a joystick for controlling the arm and the bucket.
